(19) United States
(12) Patent Application Publication
(10) Pub. No.: US 2006/0074650 A1
(43) Pub. Date: Apr. 6, 2006

(54) Speech identification system and method thereof

(75) Inventors: Xiao-Hui Shao, Taipei (TW); Chaucer Chiu, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 10/988,306

(22) Filed: Nov. 12, 2004

(30) Foreign Application Priority Data
Sep. 30, 2004 (TW) 093129523

(51) Int. Cl. G10L 15/00

(52) U.S. Cl. 704/231

(57) ABSTRACT

A speech identification system and method thereof applicable to a data processing device is proposed. An original audio frequency and a recorded audio frequency are stored via a storage unit, and set with sample frequency values using the sample frequency setting mechanism according to the preset value. Then, the original and recorded audio frequencies are transformed into waveform signals, and maximum volumes of the sample frequencies for the original and recorded audio frequencies are analyzed. The absolute values of the original and recorded audio frequencies are calculated and compared to determine an identification result. On the other hand, the original audio frequency is adjusted in a personalized manner by an audio processing mechanism to match user's audio characteristics. With the speech identification system and method thereof, the audio frequency is adjusted according to user's characteristics so as to increase accuracy in speech identification.

### BACKGROUND OF THE INVENTION

1. Field of the Invention

The invention relates to a speech identification system and method thereof, and more particularly, to a speech identification system and method thereof applicable to a data processing device.

2. Description of the Related Art

With a rapid advance in the development of electronic information industry, a variety of powerful and budget electronic information products have began to appear in the market. For example, a large number of data processing devices having language learning function are available for the consumers who wish to communicate with people speaking in foreign languages. When the language learning is conducted via the data processing device, such as computer or electronic dictionary, the researcher has to deal with the issues as to provide the learner with an almost human-like environment, so as to achieve language learning merely via the interacting with the data processing device instead of actual human interaction.

An intelligent mandarin speech learning system and method thereof is disclosed in Taiwanese Patent, TW308666 and characterized by detecting via the machine for the featured parameters corresponding to speech signal of the learning example input by the user, followed by identifying the input speech of the learning example, calculating the identifying result, and comparing with the learning example to obtain a match ratio via a identifying device, and for training the user's speech model and updating information thereof via a training device. After being trained with a group of learning examples, the user's speech model covers almost the entire speech characteristics. So, as a user is logged on-line, the user's input signal can be identified according to the speech characteristics in the speech model.

The speech learning and identifying system and method thereof described above is the conventional technique adopted by the speech identification system at present, but such technique is present with a significant drawback. That is, the user has to read the sentence examples according to approximately preset standard speed and volume so as to establish the user' speech characteristics for lowering chance of system identification error, and to set up a habit of inputting the speech in a clear and stable reading manner. As the speech characteristics is established and identified by the method, which require user to adapt to identification habit of the machine, it is less user friendly and an awkward user usually has to repeat several times to obtain a better identification result. Also, if there is a change for the user, the user's characteristics have to be re-established for identification.

Therefore, the conventional speech identification technique is still associated with two main problems today. On the one hand, the learner can not determine the sampling frequency. In other words, the learner can not determine level of audio resolution. Although a higher resolution enables the learner to learn more accurate pronunciation, a hassle of low identification successful rate is correspondingly created. On the other hand, the language identification function in the current language learning system does not provide the user with possibility to modify speed and frequency for playing the speech according to the user's need, thereby is lack of personalized speech identification function. As a result, the learner is barred from learning language in an environment close to self-pronunciation to improve learning efficiency.

Therefore, it has become a current subject for the researcher to develop a more user-personalized speech identification system and method thereof.

### SUMMARY OF THE INVENTION

In light of the drawbacks above, the primary objective of the present invention is to provide a speech identification system and method thereof such that a sample frequency is set according to actual needs.

Another objective of the present invention is to provide a speech identification system and method thereof such that speed and frequency for playing a speech are set according to actual needs.

In accordance with the above and other objectives, the present invention proposes a speech identification system which comprises a storage unit for storing at least original audio frequency, recorded audio frequency, and identification standard; a sample frequency setting module for setting the sample frequency values of the original audio frequency and the recorded audio frequency according to a preset value; an audio waveform signal transformation module for transforming the original audio frequency and the recorded audio frequency into the waveform signal; an analysis module for analyzing maximum volumes of the original audio frequency and the recorded audio frequency; a calculation module for calculating the absolute values of the original audio frequency and the recorded audio frequency respectively; a determination module for comparing the absolute values of the original audio frequency and the recorded audio frequency according to the identification standard to determine a identification result; and an audio processing module for setting speed and frequency for playing the speech.

With the speech identification system, a speech identification method is carried out. The method comprises steps of providing a storage unit for storing at least original audio frequency, recorded audio frequency, and identification standard; providing an audio processing module for setting speed and frequency for playing the speech; providing a sample frequency setting module for setting the sample frequency values of the original audio frequency and the recorded audio frequency according to a preset value; providing an audio waveform signal transformation module for transforming the original audio frequency and the recorded audio frequency into the waveform signal; providing an analysis module for analyzing maximum volumes of the original audio frequency and the recorded audio frequency; providing a calculation module for calculating the absolute values of the original audio frequency and the recorded audio frequency respectively; and providing a determination module for comparing the absolute values of the original audio frequency and the recorded audio frequency according to the identification standard to determine an identification result.

In contrast to the conventional speech identification technique, the speech identification system and method thereof enables setting of not only sample frequency, but also speed and frequency for playing the speech according to the actual needs. Therefore, a language learner can learn in an environment close to self-pronunciation to improve efficiency in language learning.

To provide a further understanding of the invention, the following detailed description illustrates embodiments and examples of the invention, it is to be understood that this detailed description is being provided only for illustration of the invention and not as limiting the scope of this invention.

### BRIEF DESCRIPTION OF THE DRAWINGS

The drawings included herein provide a further understanding of the invention. A brief introduction of the drawings is as follows:

FIG. 1 illustrates a basic architecture for a speech identification system according to the present invention; and

FIG. 2 is a flow chart illustrating a speech identification method according to the present invention.

### DETAILED DESCRIPTION OF THE EMBODIMENTS

The present invention is described in details with reference to the specific embodiments below. Other advantages and benefits associated with the present invention may be easily understood by one skilled in the pertinent art from the disclosure of the specification and illustrations thereof. Alternatively, the present invention may also be carried out or applied in other embodiments, while a variety of details may be modified or changed in several ways without departing from the gist of the invention.

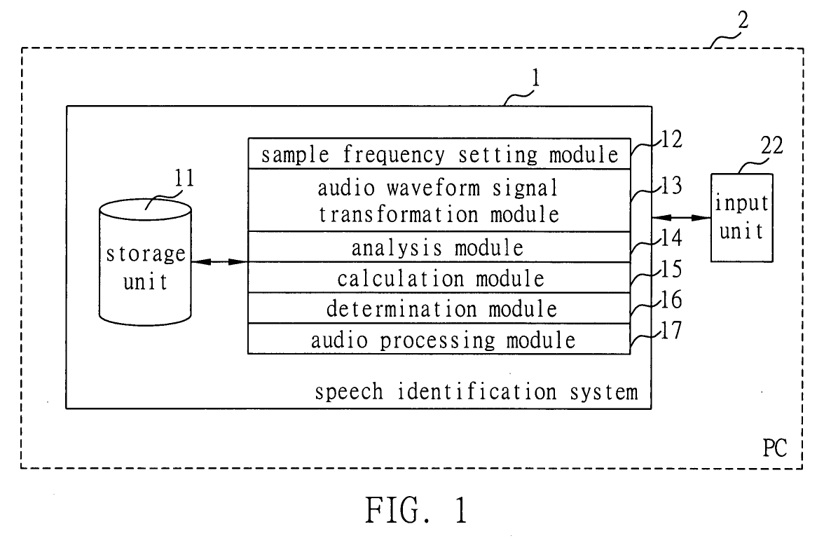

Referring to FIG. 1, a speech identification system of the present invention includes a storage unit 11, a sample frequency setting module 12, an audio waveform signal transformation module 13, an analysis module 14, a calculation module 15, a determination module 16, and an audio processing module 17.

In the present embodiment, the speech identification system 1 is applicable to a personal computer (PC) 2. More specifically, the speech identification system 1 serves to provide voiced language learning function in the PC 2. Also, the PC 2 includes an input unit 22, such as a microphone for inputting the audio data. It should be noted that the PC 2 further comprises other software and/or hardware for data computation. However, only parts related to the speech identification system 1 are illustrated to avoid complicating the technical feature of the present invention. Moreover, the PC 2 may also be replaced by other data processing devices, such as electronic dictionary, personal digital assistant (PDA), and mobile phone capable of supporting speech input/output function.

The storage unit 11 serves to store at least original audio frequency, recorded audio frequency, and preset identification standard. In the present embodiment, the storage unit 11 is a hard disk device, which stores not only the original audio frequency, the recorded audio frequency, and the identification standard, but also data generated by the PC 2 during execution of the speech identification system 1 of the present invention.

The sample frequency setting module 12 serves to set sample frequency values for the original audio frequency and the recorded audio frequency according to the preset values. When an analog audio frequency is transformed into a digital audio frequency, a sample frequency is determined to provide a basis for number of samples taken at each second during the process of transforming the analog audio signal to the digital audio signal.

Generally, the quality achieved for audio output is only half of that for the sample frequency. Therefore, it is necessary to accurately represent the original sound by adopting double sample frequencies. Under normal circumstances, a normal person's hearing limit is about 20 KHz, so a high quality sample should be twice of that. While the audio source is music having wider frequency change, the frequency of 44.1 KHz is adopted as the standard for CD music sample frequency. But if the audio source were mainly made of speech, it would be sufficient to only sample 22 KHz in the multiple sampling since the frequency of human speech is about 10 KHz. As the sampling rate is higher, the recorded audio quality is clearer, and the size of file recorded as a result of higher sampling rate is certainly getting larger. In the present embodiment, the speech identification system 1 serves to identify the speech, so the sampling frequency can be set as 22 KHz. Additionally, the sampling resolution can be set according to the user' need as eight bits, sixteen bits or higher. Since the sampling resolution is not directly related to the technical field of the invention, the details thereof are omitted herein.

The audio waveform transformation module 13 serves to transform the original audio frequency and recorded audio frequency into waveform signals according to sample frequency values set by the sample frequency setting module 12. In the present embodiment, the audio waveform transformation module 13 adopts a digital audio file in a “.WAV” format commonly used in the PC 2. It should be noted that the frequency waveform transformation module 13 may alternatively adopt other audio frequency waveform signal transformation formats, such as “.au”, “.snd”, “.voc”, “.aiff”, “.afc”, “.iff” or “.mat”. These conventional frequency waveform signal transformation formats are well known to one ordinary skilled in the art, the details are not further described herein.

The analysis module 14 serves to analyze the maximum volume for the sample frequencies of the original audio frequency and the recorded audio frequency. The analog audio frequency is a continuous signal before entering the PC 2, and the continuous signal is continuous in terms of time. The analog signal is transmitted via the input unit 22 to the PC 2 in a digital processing. After the digital processing, the continuous analog audio frequency signal is transformed into a discontinuous signal, and the transformed waveform signals only show certain fixed time scale values that are analyzed by the analysis module 14. In the present embodiment, the time scale value may be volt (V) or decibel (dB).

The calculation module 15 serves to calculate the absolute values of the original audio frequency and recorded audio frequency. In the present embodiment, the absolute values are calculated based on the each time scale value for the original audio frequency and recorded audio frequency. That is, each time scale value is divided by the V or dB value on the time scale to obtain the absolute value.

The determination module 16 serves to determine the identification result by comparing the absolute values of the original audio frequency and recorded audio frequency according the identification standard. In the present embodiment, the identification standard may be the degree of resemblance by comparing the absolute value of the original audio frequency with that of the recorded audio frequency at each time scale. More specifically, the degree of resemblance in percentage is calculated by dividing a difference between absolute values of the original audio frequency and the recorded audio frequency with the absolute value of the original audio frequency. After degrees of resemblance for all time scales are calculated, a gross average is further calculated for the degrees of resemblance for all time scales. If the speech identification system 1 is further applicable to pronunciation verification function in the language learning software, the gross average value may serve as a basis for the verification.

The audio processing module serves 17 serves to set speed and frequency for playing the speech. In the present embodiment, the audio processing module 17 can speed up/slow down the transmission of the original audio signal data to match speaking pace of different users via the time sequence modification. On the other hand, the level of the original audio tone is directly proportional to speed of the vibration. Therefore, a faster vibration at a given time would result a higher frequency as well as a higher tone. As a result, the frequency of the original audio data is modified to change tone of the original audio data, so as to approach to female or male vocal and similarly match the speaking tone of different users.

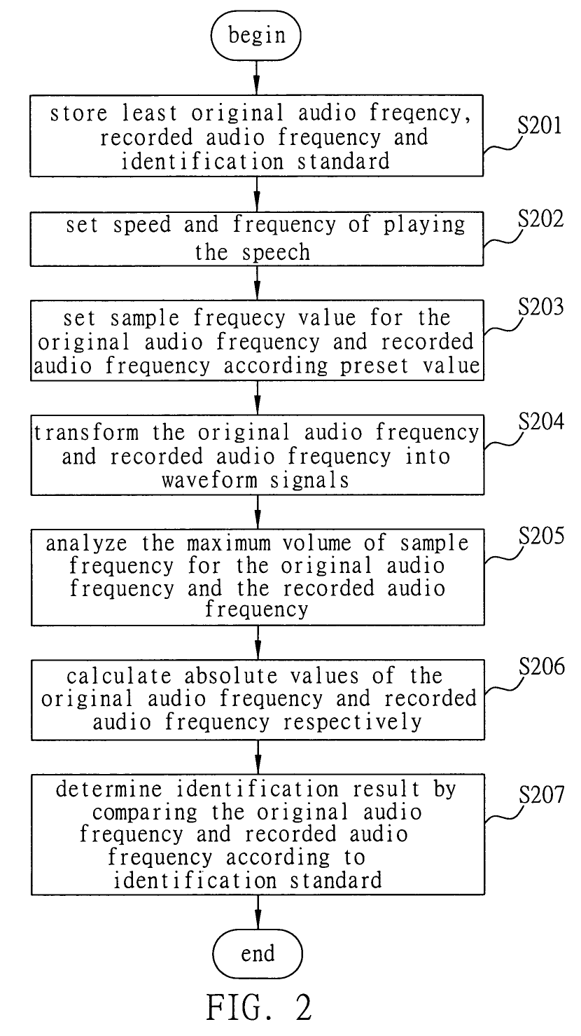

Referring to FIG. 2 for illustrating flowchart of speech identification method according to the present invention.

In step S201, a storage unit 11 is provided to store at least original audio data, recorded audio data, and preset identification standard. Next, the method proceeds to step S202.

In step S202, an audio processing module 17 is provided to set speed and frequency for playing the speech. In the present embodiment, the audio processing module 17 can speed up/slow down the speed of transmitting the original audio data via time sequence modification. On the other hand, the frequency of the original audio data is further modified to change tone of the original audio data. Next, the method proceeds to step S203.

In step S203, a sample frequency setting module 12 is provided to set sample frequency values for the original and recorded audio based on preset values. In the present embodiment, the speech identification system 1 serves to identify the speech, so the sampling frequency can be set as 22 KHz. Next, the method proceeds to step S204.

In step S204, an audio waveform signal transformation module 13 is provided to transform the original and recorded audio frequencies into waveform signals according to the sample frequency value set by the sample frequency setting module 12. In the present embodiment, the audio waveform signal transformation module 13 adopts the “.WAV” file which is a digital audio file format commonly used in the PC. Next, the method proceeds to step S205.

In step S205, an analysis module 14 is provided to analyze maximum volumes of the original and recorded audio sample frequencies. In the present embodiment, the time scale value is in volt (V) or decibel (dB). Next, the method proceeds to step S206.

In step S206, a calculation module 15 is provided to calculate the absolute values for the original and recorded audio frequencies. In the present embodiment, the absolute value is calculated according to each time scale value for the original and recorded audio frequencies. That is, the absolute value is obtained by dividing each time scale by the V or dB value on the time scale. Next, the method proceeds to step S207.

In step S207, a determination module 16 is provided to determine the identification result by comparing the absolute values of the original and recorded audio frequencies according to the identification standard. In the present embodiment, the identification standard may be the degree of resemblance by comparing the absolute value of the original audio frequency calculated by the calculation module 15 at each time scale with the absolute value of the recorded audio frequency. More specifically, the identification standard may be the degree of resemblance in percentage obtained by dividing the difference in absolute values of the original and recorded audio frequencies with the absolute value of the original audio frequency. After degrees of resemblance for all time scales are calculated, a gross average is further calculated for the degrees of resemblance for all time scales.

Summarizing from the above, the speech identification system and method thereof enables setting of not only sample frequency, but also speed and frequency for playing the speech according to the actual needs. Therefore, a language learner can learn in an environment close to self-pronunciation to improve efficiency in language learning.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A speech identification system applicable to a data processing device, the system comprising:
a storage unit for storing the at least original audio frequency, recorded audio frequency, and identification standard;
a sample frequency setting module for setting the sample frequency values of the original audio frequency and the recorded audio frequency according to a preset value;
an audio waveform signal transformation module for transforming the original audio frequency and the recorded audio frequency into waveform signals;
an analysis module for analyzing maximum volumes of the original audio frequency and the recorded audio frequency;
a calculation module for calculating the absolute values of the original audio frequency and the recorded audio frequency respectively;
a determination module for comparing the absolute values of the original audio frequency and the recorded audio frequency according to the identification standard to determine an identification result; and
an audio processing module for setting speed and frequency for playing a speech.

2. The speech identification system of claim 1, wherein the sample frequency includes 44.1 KHz and 22 KHz.

3. The speech identification system of claim 1, wherein a waveform signal transformation format of the frequency waveform signal transformation module is one file format selected from a group consisting of “.wav”, “.au”, “.snd”, “.voc”, “.aiff”, “.afc”, “.iff” and “.mat”.

4. The speech identification system of claim 1, wherein the volume value on the waveform signal time scale includes volt (V) and decibel (dB).

5. The speech identification system of claim 1, wherein the absolute value is calculated according to each time scale value for the original audio frequency and the recorded audio frequency.

6. The speech identification system of claim 1, wherein identification standard is a degree of resemblance by comparing the absolute value of the original audio frequency at each time scale calculated by the calculation module with the absolute value of the recorded audio frequency at each time scale.

7. The speech identification system of claim 6, wherein the degree of resemblance for the absolute value is a value obtained by dividing a difference between the absolute values of the original audio frequency and the recorded audio frequency with the absolute value of the original audio frequency.

8. The speech identification system of claim 6, wherein the determination module further obtains a gross average for degrees of resemblances at all time scales after the degrees of resemblances at all time scales are calculated.

9. The speech identification system of claim 1, wherein the audio processing module adjusts the speed of the original audio frequency via sequence modification.

10. The speech identification system of claim 1, wherein the audio processing module modifies frequency of the original audio data to modify tone of the original audio data.

11. A speech identification method performed with a speech identification system having a storage unit is applicable to a data processing device, the method comprising steps of:
storing an original audio frequency, a recorded audio frequency, and identification standard data in the storage unit;
commanding the system for setting speed and frequency for playing a speech;
commanding the system for setting the sample frequency values of the original audio frequency and the recorded audio frequency according to a preset value;
commanding the system for transforming the original audio frequency and the recorded audio frequency into the waveform signal;
commanding the system for analyzing maximum volumes of the original audio frequency and the recorded audio frequency;
commanding the system for calculating the absolute values of the original audio frequency and the recorded audio frequency respectively; and
commanding the system for comparing the absolute values of the original audio frequency and the recorded audio frequency according to the identification standard to determine an identification result.

12. The speech identification method of claim 11, wherein the sample frequency includes 44.1 KHz and 22 KHz.

13. The speech identification method of claim 11, wherein the system further comprising an audio processing module, a sample frequency setting module, an audio waveform signal transformation module, a calculation module, and a determination module.

14. The speech identification method of claim 13, wherein the audio waveform signal transformation module having a waveform signal transformation format selected from a group consisting of “.wav”, “.au”, “.snd”, “.voc”, “.aiff”, “.afc”, “.iff” and “.mat”.

15. The speech identification method of claim 11, wherein the volume value on the waveform signal time scale includes volt (V) and decibel (dB).

16. The speech identification method of claim 11, wherein the absolute value is calculated according to each time scale value for the original audio frequency and the recorded audio frequency.

17. The speech identification method of claim 11, wherein identification standard is degree of resemblance by comparing the absolute value of the original audio frequency at each time scale calculated by the system with the absolute value of the recorded audio frequency at each time scale.

18. The speech identification method of claim 17, wherein the degree of resemblance for the absolute value is a value obtained by dividing a difference between the absolute values of the original audio frequency and the recorded audio frequency with the absolute value of the original audio frequency.

19. The speech identification method of claim 17, wherein the system further obtains a gross average for degrees of resemblances at all time scales after the degrees of resemblances at all time scales are calculated.

20. The speech identification method of claim 11, wherein the system adjusts the speed of the original audio frequency via sequence modification.

21. The speech identification method of claim 11, wherein the system modifies frequency of the original audio data to modify tone of the original audio data.
